(19) United States
(12) Patent Application Publication
(10) Pub. No.: US 2004/0151650 A1
(43) Pub. Date: Aug. 5, 2004

(54) Method of preparing calcium silicate hydrate granules and use thereof

(76) Inventor: Dietmar Lange, Vallendar (DE)

Correspondence Address: FULBRIGHT & JAWORSKI, LLP, 1301 MCKINNEY, SUITE 5100, HOUSTON, TX, 77010-3095, US

(21) Appl. No.: 10/475,467

(22) PCT Filed: Apr. 19, 2002
(86) PCT No.: PCT/EP02/04333

(30) Foreign Application Priority Data
Apr. 27, 2001 (DE) 10121098.1

(51) Int. Cl. A01K 29/00; C01B 33/24

(52) U.S. Cl. 423/331; 119/173

(57) ABSTRACT

A method of preparing calcium silicate hydrate granules by reacting crystalline and optionally amorphous silica or materials containing same with calcium oxide or materials containing same by homogenising them in water, moulding, autoclave curing, comminuting, drying and classifying, the homogenisation being performed by dispersing the solid starting materials in water while adding an anionic surfactant that has previously been converted in water into a microporous stable foam, wherein the homogenised mixture is filled, to a maximum depth of 60 cm, into moulds which are at least 5 square metres in area; a product obtainable by this method and its use as or in animal litter.

### CROSS-REFERENCE TO RELATED APPLICATIONS

This application is a national stage application of PCT/EP02/04333 filed Apr. 19, 2002 claiming priority to DE 101 21 098.1 filed Apr. 27, 2001.

### TECHNICAL FIELD

The invention relates to a method of preparing calcium silicate hydrate granules by reacting crystalline and optionally amorphous silica or materials containing same with calcium oxide or materials containing same by homogenising them in water, moulding, autoclave curing, comminuting, drying and classifying, the homogenisation during the reaction being performed by dispersing the solid starting materials in water while adding an anionic surfactant that has previously been converted in water into a microporous stable foam; the invention also relates to a product obtainable by this method and its use. Not applicable.

### BACKGROUND OF THE INVENTION

Known materials for animal litter are usually natural products of mineral or organic origin, such as pumice stone, clay minerals, moler earth, wood dust, peat and diatomaceous earth, which, because of their porous structure, possess the ability to absorb liquids.

DE-AS 2902079 discloses an animal litter for which calcium silicate hydrate granules manufactured as specified above are used.

DE 3121403 discloses a further development of this animal litter in which, in order to bind odours, the pH is lowered to a level between about 5.8 and 6.2 using acidic materials.

Furthermore, EP 0 109 267 A1 teaches treating various solid absorbent materials with water-soluble salts of transition metals from Groups Ib or IIb of the periodic table, and EP 0 204 152 C1 teaches treating with zinc salts, while adjusting a particular zinc content and pH level, in both cases likewise in order to improve odour binding.

Finally, DE 41 09 590 C1 discloses an animal litter in which, in order to improve odour binding, the water activity is adjusted to about 0.95 or less by treating it with a salt or salt mixture taken from the group of alkali metal and earth alkali metal chlorides.

Whereas different methods have therefore been adopted to improve absorbent materials for animal litter with regard to odour binding by means of an appropriate treatment, one of the commercially most important absorbent materials itself, namely artificially produced calcium silicate hydrate granules, is essentially still produced in exactly the same way as described in DE-AS 29 02 079.

### BRIEF SUMMARY OF THE INVENTION

The object of the present invention is to improve this known absorbent material in such a way that the properties of the material which are relevant to its use as animal litter, especially its absorbtivity, are improved at least in part.

According to the invention, this problem is solved in that, in the method described in the preamble, the homogenised mixture is filled, to a maximum depth of 60 cm, into moulds which are at least 5 square metres in area.

In a preferred embodiment, the mouldings—with or without the moulds —are autoclaved without being divided or comminuted beforehand.

It is particularly preferred for the moulds to be at least 10 square metres in area.

In a preferred embodiment of the invention, the mouldings are comminuted in two stages after autoclaving, a particle fraction of up to 15 cm being obtained in the first stage, and a particle fraction of up to 5 mm being obtained in the second stage.

In accordance with the invention, it is particularly preferred for particles with a size of less than 0.5 mm to be removed between the two comminution stages.

The invention also relates to calcium silicate hydrate granules obtainable according to the method of the invention and the use of such calcium silicate hydrate granules as or in animal litter.

### DETAILED DESCRIPTION OF THE INVENTION

It has now surprisingly been found that, with the new production method, a material with improved properties can be obtained, in particular with improved water absorption, i.e. absorbtivity, lower bulk density (and thus lower bulk weight) and a larger surface area. In this way, a material can be provided which is superior to the known materials for use as or in animal litter.

The two main starting materials—as in the prior art—are preferably pure, finely ground quartz sand (SiO₂) and burnt white fine lime (CaO). The two materials are blended into a sufficient quantity of water, the weight ratio of CaO:SiO₂ being between 0.4 and 0.6, preferably between 0.46 and 0.51. Mixing is preferably carried out in a blade mixer at a relatively low stirring speed.

After stirring for a short time (e.g. 60 sec), a foam gun is used to add a microporous stable foam obtained by foaming an anionic surfactant. Surfactants preferably used are anionic, biodegradable surfactants, e.g. mixtures of alkene sulphonates and hydroxyalkane sulphonates, such as the product HOSTAPUR-OS®. If necessary, in order to stabilise the foam, an anion-active stabiliser can be added, e.g. an alkyl triglycol ether sulphate, such as the product Zeliquid LP-2.

After the foam has been added and worked in, the mixture is poured into casting moulds which are at least 5 square metres, preferably 10 square metres, in size, such as 6 m×2 m. The relatively large area of the casting moulds—conventionally, the maximum size of the casting moulds used is 2.5 square metres—and the fact that the homogenised mixture is filled, to a maximum depth of 60 cm—conventionally, the depth is at least 90 cm—leads—especially if the autoclaving is performed without the mouldings' being divided or comminuted beforehand —to mouldings with a more homogeneous, finer porosity, which leads to a distinct improvement in and greater uniformity of the above-mentioned material properties, especially water absorption, i.e. absorbtivity, bulk density and surface area.

The mouldings are preferably autoclaved in the following cycle:

vacuum: 0.75 to 1.5 h, preferably 1 h, to 0.3 to 0.5 bar, preferably 0.4 bar

heating: 0.75 to 1.5 h, preferably 1 h, to 2.5 to 4 bar, preferably 3 bar

heating: 1.25 to 2 h, preferably 1.5 h, to 12 to 16 bar, preferably 15 bar

holding time: 0.75 to 1.5 h, preferably 1 h, at 12 to 16 bar, preferably 15 bar

heating: 5 to 15 min, preferably 8 min, to 14 to 18 bar, preferably 16 bar

holding time: 3 to 6 h, preferably 4.5 h, at 14 to 18 bar, preferably 16 bar

cooling time: approx. 3 h.

Following the autoclaving, the mouldings are comminuted to the desired particle size, preferably in two stages, a particle fraction of up to 15 cm being obtained in the first stage, and a particle fraction of up to 5 mm being obtained in a second stage.

In order to remove particles with a particle size of less than 0.5 mm, the comminuted material is preferably subjected to sifting between the two comminution stages. In this way, the amount of dust in the final product can be reduced.

The invention will now be described in more detail with reference to the following example.

### EXAMPLE 1

The following starting materials were used to prepare the calcium silicate hydrate granules of the invention:

40.3% by weight quartz powder

20.1% by weight lime

39.6% by weight water

The water was introduced into an Ekato mixer, type EM2100, with a mixer blade diameter of 1,700 mm. The starting materials, i.e. quartz powder and lime, were mixed in while stirring continued at 90 r.p.m. After they had been dispersed, a microporous stable foam (80 parts water, 1 part HOSTAPUR-OS®, 1 part Zeliquid® LP-2) prepared in an active foam generator from water and an anionic surfactant (HOSTAPUR-OS®) with the addition of a foam stabiliser (Zeliquid® LP-2) was worked in by means of a foam gun (2-3% by weight relative to the dispersion). A recirculation pump (VASA G120234-50) was used in order to improve the blending.

After that, the finished mixture was poured through a pipe into mouldings measuring 600×200×53 cm. The mouldings were then cured in autoclaves, adhering to the following cycle:

| | |
|---|---|
| vacuum: | 1 h to 0.4 bar |
| heating: | 1 h to 3 bar |
| heating: | 1.5 h to 15 bar |
| holding time: | 1 h at 15 bar |
| heating: | 8 min to 16 bar |
| holding time: | 4.5 h at 16 bar |
| cooling time: | approx. 3 h. |

The mouldings come out of the autoclave with a residual moisture of approx. 28-35% (preferably 32%) and are then initially comminuted with a roll crusher to a particle size of up to 15 cm. Following that, the fraction <0.5 mm is removed. The remaining material is comminuted to a maximum particle size of 5 mm in a second stage and is then dried to approx. 3% residual moisture.

The average figures for the material parameters of the calcium silicate hydrate granules obtained (standard fraction: fraction 0.5 to 2 mm: 25%; fraction 2-4 mm: 60%; fraction 4-5 mm: 15%) were as follows:

| | |
|---|---|
| bulk density (g/l): | 470 to 480 |
| bulk weight (g/l): | 270 to 310 |
| surface area (BET) according to DIN 66131 (m²/g): | 90 to 100 |
| water absorption: | ˜140% |
| water absorption (after spraying with MgCl₂): | 72 to 75% |

### EXAMPLE 2

### Comparative Example

A material produced in accordance with Example 1 of DE-AS 29 02 079 has substantially the same composition as the material produced in accordance with the example of the invention. The production process differs essentially in the fact that, in the state of the art, considerably smaller moulds (maximum size: 2.5 square metres) with a great depth (minimum of 90 cm) were used, which were subdivided into individual chambers by means of separating walls. This means that the casting process gave rise to blocks with a very much smaller base area but of greater height, which were subjected to autoclaving. The further processing was performed essentially in the same way as described in the example of the invention.

The average figures for the material parameters (standard fraction as in Example 1) were as follows:

| | |
|---|---|
| bulk density (g/l): | 510 to 520 |
| bulk weight (g/l): | 315 to 345 |
| surface area (BET) according to | 40 to 60 |
| DIN 66131 (m²/g): | (with considerably |
| | greater fluctuations |
| | than in the material |
| | of the invention) |
| water absorption: | ˜120% |
| water absorption (after spraying with | 66 to 68%. |
| MgCl₂): | |

It is therefore clear that the product produced in accordance with the method of the invention is characterised by a substantially lower bulk density, i.e. a substantially lower bulk weight, a larger surface area, and considerably higher water absorption. It is therefore better suited for use as or in animal litter than the known calcium silicate hydrate granules.

The features of the invention disclosed in the above description and in the claims may be essential either individually or in any combination in order to carry out the invention in its various embodiments.

What is claimed is:

1. A method of preparing calcium silicate hydrate granules by reacting crystalline and optionally amorphous silica or materials containing same with calcium oxide or materials containing same by homogenising them in water, moulding, autoclave curing, comminuting, drying and classifying, the homogenisation being performed by dispersing the solid starting materials in water while adding an anionic surfactant that has previously been converted in water into a microporous stable foam, characterised in that the homogenised mixture is filled, to a maximum depth of 60 cm, into moulds which are at least 5 square metres in area.

2. The method as claimed in claim 1, characterised in that the mouldings—with or without the moulds—are autoclaved without being divided or comminuted beforehand.

3. The method as claimed in either of claims 1 or 2, characterised in that the minimum area of the moulds is at least 10 square metres.

4. The method as claimed in any of claims 1, 2 or 3, characterised in that the mouldings are comminuted in two stages after autoclaving, a particle fraction of up to 15 cm being obtained in the first stage, and a particle fraction of up to 5 mm being obtained in the second stage.

5. The method as claimed in claim 4, characterised in that particles with a size of less than 0.5 mm to be removed between the two comminution stages.

6. Calcium silicate hydrate granules obtainable according to any of the preceding claims.

7. Use of calcium silicate hydrate granules as claimed in claim 6 as or in animal litter.
